(19) United States
(12) Patent Application Publication
(10) Pub. No.: US 2026/0046838 A1
(43) Pub. Date: Feb. 12, 2026

(54) PAGING DIFFERENTIATION

(71) Applicant: Nokia Technologies Oy, Espoo (FI)

(72) Inventors: Srinivasan SELVAGANAPATHY, Bangalore (IN); Mads LAURIDSEN, Aalborg (DK); Jeroen WIGARD, Aalborg (DK); Ping YUAN, Beijing (CN)

(21) Appl. No.: 19/101,183

(22) PCT Filed: Aug. 10, 2022
(86) PCT No.: PCT/CN2022/111572

§ 371 Date: Feb. 4, 2025

(51) Int. Cl. H04W 68/00; H04W 76/30

(52) U.S. Cl. CPC H04W 68/005; H04W 76/30

(57) ABSTRACT

Embodiments of the present disclosure relate to paging differentiation. A terminal device obtains a first paging identifier for monitoring first paging information scheduling a first paging message for a transmission of an application level feedback, the first paging identifier being different from a second paging identifier for monitoring second paging information scheduling a second paging message for a data transmission, and monitor, using the first paging identifier, the first paging information from an access network device. Paging for new packets and delivery of feedback can be differentiated to avoid false wake-up of UE not waiting for feedback.

### FIELD

Various example embodiments relate to the field of telecommunication and in particular, to methods, devices, apparatuses and a computer readable storage medium for paging differentiation.

### BACKGROUND

In the communications area, there is a constant evolution ongoing in order to provide efficient and reliable solutions for utilizing wireless communication networks. Each new generation has it owns technical challenges for handling the different situations and processes that are needed to connect and serve devices connected to the wireless network. To meet the demand for wireless data traffic having increased since deployment of 4th generation (4G) communication systems, efforts have been made to develop an improved 5th generation (5G) or pre-5G communication system. The new communication systems can support various types of service applications for terminal devices, for example, applications for IoT.

NTN (non-terrestrial network) connectivity for cellular IoT is one of the main usage situations for NTN based cellular IoT, which was originally specified in release 17 and to be enhanced in release 18. In these scenarios, the nature of IoT data traffic and also available features in terrestrial IoT features plays important role in defining solution for IoT-NTN in store and forward (SF) manner in discontinuous coverage scenarios.

### SUMMARY

In general, example embodiments of the present disclosure provide methods, devices, apparatuses and a computer readable storage medium for paging differentiation.

In a first aspect, there is provided a terminal device. The terminal device comprises at least one processor and at least one memory storing instructions. The instructions, when executed by the at least one processor, cause the terminal device at least to: obtain a first paging identifier for monitoring first paging information scheduling a first paging message for a transmission of an application level feedback, the first paging identifier being different from a second paging identifier for monitoring second paging information scheduling a second paging message for a data transmission; and monitor, using the first paging identifier, the first paging information from an access network device.

In a second aspect, there is provided an access network device. The access network device comprises at least one processor and at least one memory storing instructions. The instructions, when executed by the at least one processor, cause the access network device at least to: obtain a first paging identifier for scrambling first paging information scheduling a first paging message for a transmission of an application level feedback to a terminal device, the first paging identifier being different from a second paging identifier for scrambling second paging information scheduling a second paging message for a data transmission to the terminal device; and transmit, to the terminal device, the first paging information scrambled with the first paging identifier.

In a third aspect, there is provided a core network device. The core network device comprises at least one processor and at least one memory storing instructions. The instructions, when executed by the at least one processor, cause the core network device at least to: determine a first paging identifier for a terminal device to monitor first paging information scheduling a first paging message for a transmission of an application level feedback, the first paging identifier being different from a second paging identifier for the terminal device to monitor second paging information scheduling a second paging message for a data transmission; and transmit the first paging identifier to an access network device to which the terminal device is to connect.

In a fourth aspect, there is provided a method implemented at a terminal device. The method comprises obtaining, at a terminal device, a first paging identifier for monitoring first paging information scheduling a first paging message for a transmission of an application level feedback, the first paging identifier being different from a second paging identifier for monitoring second paging information scheduling a second paging message for a data transmission; and monitoring, using the first paging identifier, the first paging information from an access network device.

In a fifth aspect, there is provided a method implemented at an access network device. The method comprises: obtaining, at an access network device, a first paging identifier for scrambling first paging information scheduling a first paging message for a transmission of an application level feedback to a terminal device, the first paging identifier being different from a second paging identifier for scrambling second paging information scheduling a second paging message for a data transmission to the terminal device; and transmitting, to the terminal device, the first paging information scrambled with the first paging identifier.

In a sixth aspect, there is provided a method implemented at a core network device. The method comprises: determining, at a core network device, a first paging identifier for a terminal device to monitor first paging information scheduling a first paging message for a transmission of an application level feedback, the first paging identifier being different from a second paging identifier for the terminal device to monitor second paging information scheduling a second paging message for a data transmission; and transmitting the first paging identifier to an access network device to which the terminal device is to connect.

In a seventh aspect, there is provided an apparatus comprising means for obtaining, at a terminal device, a first paging identifier for monitoring first paging information scheduling a first paging message for a transmission of an application level feedback, the first paging identifier being different from a second paging identifier for monitoring second paging information scheduling a second paging message for a data transmission; and means for monitoring, using the first paging identifier, the first paging information from an access network device.

In an eighth aspect, there is provided an apparatus comprising means for obtaining, at an access network device, a first paging identifier for scrambling first paging information scheduling a first paging message for a transmission of an application level feedback to a terminal device, the first paging identifier being different from a second paging identifier for scrambling second paging information scheduling a second paging message for a data transmission to the terminal device; and means for transmitting, to the terminal device, the first paging information scrambled with the first paging identifier.

In a ninth aspect, there is provided an apparatus comprising means for determining, at a core network device, a first paging identifier for a terminal device to monitor first paging information scheduling a first paging message for a transmission of an application level feedback, the first paging identifier being different from a second paging identifier for the terminal device to monitor second paging information scheduling a second paging message for a data transmission; and means for transmitting the first paging identifier to an access network device to which the terminal device is to connect.

In a tenth aspect, there is provided a non-transitory computer readable medium comprising program instructions that, when executed by an apparatus, cause the apparatus to perform at least the method of any one of above fourth to sixth aspect.

In a eleventh aspect, there is provided a non-transitory computer readable medium comprising program instructions stored thereon for performing at least the method of any one of above fourth to sixth aspect.

In a twelfth aspect, there is provided a computer program comprising instructions, which, when executed by an apparatus, cause the apparatus at least to: obtain a first paging identifier for monitoring first paging information scheduling a first paging message for a transmission of an application level feedback, the first paging identifier being different from a second paging identifier for monitoring second paging information scheduling a second paging message for a data transmission; and monitor, using the first paging identifier, the first paging information from an access network device.

In a thirteenth aspect, there is provided a computer program comprising instructions, which, when executed by an apparatus, cause the apparatus at least to: obtain a first paging identifier for scrambling first paging information scheduling a first paging message for a transmission of an application level feedback to a terminal device, the first paging identifier being different from a second paging identifier for scrambling second paging information scheduling a second paging message for a data transmission to the terminal device; and transmit, to the terminal device, the first paging information scrambled with the first paging identifier.

In a fourteenth aspect, there is provided a computer program comprising instructions, which, when executed by an apparatus, cause the apparatus at least to: determine a first paging identifier for a terminal device to monitor first paging information scheduling a first paging message for a transmission of an application level feedback, the first paging identifier being different from a second paging identifier for the terminal device to monitor second paging information scheduling a second paging message for a data transmission; and transmit the first paging identifier to an access network device to which the terminal device is to connect.

In a fifteenth aspect, there is provided a terminal device. The terminal device comprises obtaining circuitry configured to obtain a first paging identifier for monitoring first paging information scheduling a first paging message for a transmission of an application level feedback, the first paging identifier being different from a second paging identifier for monitoring second paging information scheduling a second paging message for a data transmission; and monitoring circuitry configured to monitor, using the first paging identifier, the first paging information from an access network device.

In a sixteenth aspect, there is provided an access network device. The access network device comprises obtaining circuitry configured to obtain a first paging identifier for scrambling first paging information scheduling a first paging message for a transmission of an application level feedback to a terminal device, the first paging identifier being different from a second paging identifier for scrambling second paging information scheduling a second paging message for a data transmission to the terminal device; and transmitting circuitry configured to transmit, to the terminal device, the first paging information scrambled with the first paging identifier.

In a seventeenth aspect, there is provided a core network device. The core network device comprises determining circuitry configured to determine a first paging identifier for a terminal device to monitor first paging information scheduling a first paging message for a transmission of an application level feedback, the first paging identifier being different from a second paging identifier for the terminal device to monitor second paging information scheduling a second paging message for a data transmission; and transmitting circuitry configured to transmit the first paging identifier to an access network device to which the terminal device is to connect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A illustrates an example communication network in which embodiments of the present disclosure may be implemented;

FIG. 1B illustrates example scenarios in which some embodiments of the present disclosure may be implemented;

FIG. 2 illustrates an example of method in accordance with some embodiments of the present disclosure;

FIG. 3 illustrates flow diagram of terminal device receiving the application level feedback from the access network device in accordance with some embodiments of the present disclosure;

FIG. 4 illustrates flow diagram of terminal device receiving the application level feedback from the access network device in accordance with some other embodiments of the present disclosure;

FIG. 5 illustrates the message sequence diagram for paging differentiation for SF paging message along with enhancement for group based application feedback notification;

FIG. 6 illustrates a flowchart of an example method implemented at the terminal device in accordance with some embodiments of the present disclosure;

FIG. 7 illustrates a flowchart of an example method implemented at the access network device in accordance with some embodiments of the present disclosure;

FIG. 8 illustrates a flowchart of an example method implemented at a core network device in accordance with some embodiments of the present disclosure;

FIG. 9 illustrates a simplified block diagram of an apparatus that is suitable for implementing embodiments of the present disclosure; and

FIG. 10 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment”and “UE” may be used interchangeably.

NTN connectivity for cellular IoT is one of the main usage situations for NTN based cellular IoT, which was originally specified in release 17 and to be enhanced in release 18. In these scenarios, the nature of IoT data traffic and also available features in terrestrial IoT features plays important role in defining solution for IoT-NTN in store and forward manner in discontinuous coverage scenarios.

Following IoT features already defined in current specifications are enhanced for NTN connectivity with discontinuous coverage where NW implements store and forward concept, Rel-14 NB-IoT/eMTC supports early data transmission (EDT) feature where single user packet is transmitted during RACH procedure, there is not RRC connection is established for EDT, so that energy efficient procedure is implemented for small data transmission. For EDT variants based on security of user packet, one solution is that EDT packet uses AS security keys, and UE and AS preserve AS security context on entering to idle. Another solution is EDT packet uses NAS security keys, and ENB don't intercept the packet.

NTN network operating in store and forward mode for discontinuous coverage is a new problem space. 3GPP intend to handle this scenario in 3GPP-Rel-19. In regular paging (TS 36.304) the UE will monitor the paging Downlink Control Information (DCI), which is scrambled with P-RNTI (Paging RNTI). If the paging DCI scrambled with P-RNTI is detected, the UE will monitor the corresponding, scheduled resources on Physical Downlink Shared Channel (PDSCH). The data on PDSCH is known as the paging message. The message contains a list of UE IDs. If the UE detects its own UE ID it will initiate connection setup.

In some schemes, the UE in NTN-SF network may buffer application packets and stop retransmission until they get application feedback for earlier transmissions, but these schemes are merely applicable for packets which require confirmation (confirmable COAP, TCP-ACK). In some other schemes, depending on duration of GW connectivity and application server and also load of pending message, GW may provide response to some UE, however, some UE may need to wait for longer time.

The technique for enhancements of small data transmission for NTN network operating in SF mode is to be needed, all UEs waiting for feedback need not resume the connection next time for receiving application feedback, and paging for new packets and delivery of feedback can be differentiated to avoid false wake-up of UE not waiting for feedback.

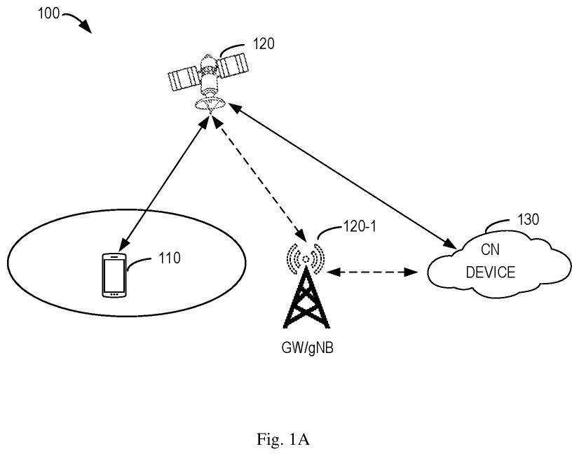

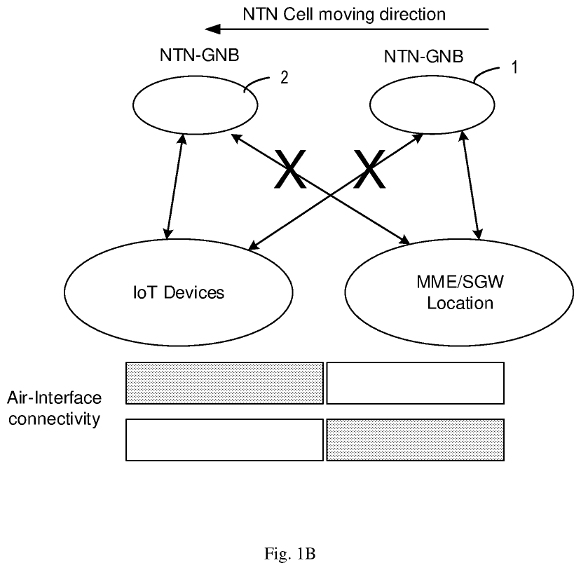

Principle and embodiments of the present disclosure will be described in detail below with reference to the accompanying drawings. Reference is first made to FIG. 1A, which illustrates an example communication system 100 in which embodiments of the present disclosure may be implemented. As shown in FIG. 1A, FIG. 1A illustrates an example system 100 in which some example embodiments of the present disclosure may be implemented. The system 100 may include a terminal device 110 and a satellite 120. As shown in FIG. 1A, the system 100 may include a NTN comprising the satellite 120 in communication with the terminal device 110. The device 120-1 shown in FIG. 1A may be a gateway (GW) device or a base station.

In some embodiments, the device 120-1 may be a BS 120-1 (such as a gNB). The satellite 120 may communicate with the terminal device 110 via a service link or a wireless interface, and the satellite 120 may communicate with the BS 120-1 via a feeder link or a wireless interface. In some embodiments, the satellite 120 may operate as a passive or transparent network relay node between the terminal device 110 and the BS 120-1. As shown in FIG. 1, the BS 120-1 may further communicate with a core network (CN) device 130, for example via a gateway device. In some other embodiments, the device 120-1 may be a gateway device 120-1. In some embodiments, the satellite 120 may communicate with the gateway device 120-1 associated with the CN device 130.

In some other embodiments, the satellite 120 may operate as a further BS, such as another gNB, and can be called as access network device 120, and CN device 130 can be called as core network device 130. In communication systems, an UL refers to a link in a direction from a terminal device 110 to an access network device 120, and a DL refers to a link in a direction from the access network device 120 to the terminal device 110. The access network devices 120 also communicate with the core network device 130, for example the access network devices 120 may obtain the feedback for transmitting to the terminal devices 110 from the core network device 130. In some scenarios, the connection between the access network devices 120 and the terminal device 110, and the connection between the access network devices 120 and the core network devices 130 do not exist simultaneously.

It is to be understood that the number of the access network devices 120 and the terminal devices 110 is only for the purpose of illustration without suggesting any limitations. The system 100 may include any suitable number of access network devices 120 and terminal devices 110 adapted for implementing embodiments of the present disclosure. Although not shown, it would be appreciated that one or more terminal devices 110 may be located in a cell.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

FIG. 1B illustrates example scenarios in which some embodiments of the present disclosure may be implemented. When cellular coverage is provided from non-terrestrial base stations depending on the coverage foot-print and number of satellites there will be discontinuity of coverage situation for UE. This is also applicable for the NTN GNB/ENB connectivity with GW (Gateway)/CN (Core Network) elements also if the NTN is deployed as ‘GNB’ in satellite and there are a limited number of GWs. In this situation, there will be need for store and forward of data packets due to possibility of UE and GW connectivity at different time instances for a satellite. The situation is illustrated in FIG. 1B, as shown in FIG. 1B, When NTN cell is at position 1, NTN-GNB establishes connection with MME/SGW but disconnects from IoT devices. As NTN cell moves, at position 2, NTN-GNB disconnects from MME (Mobility Management Entity)/SGW but establishes connection with IoT devices.

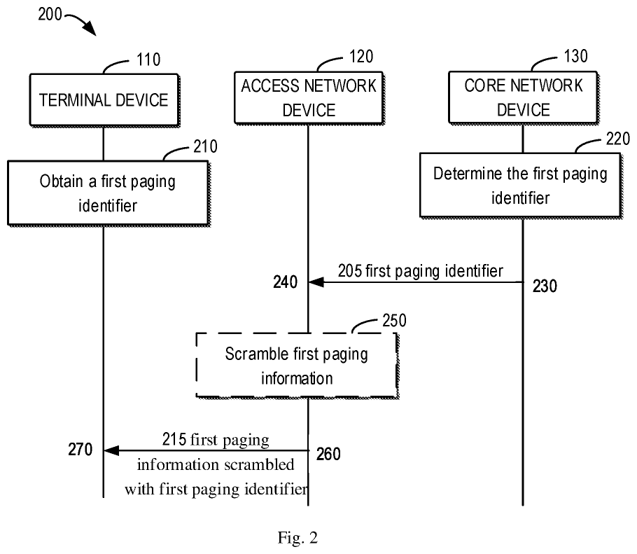

FIG. 2 illustrates an example of method in accordance with some embodiments of the present disclosure. As shown in FIG. 2, according to an example of method 200, the terminal device 110 may obtain (210) a first paging identifier 205 for monitoring first paging information 215 scheduling a first paging message for a transmission of an application level feedback. The first paging identifier is different from a second paging identifier for the terminal device 110 to monitor second paging information scheduling a second paging message for a data transmission. On the side of the core network device 130, the core network device 130 may determine (220) the first paging identifier 205. The core network device 130 may transmit (230) the first paging identifier 205 to the access network device 120 to which the terminal device 110 is to connect. Accordingly, the access network device 120 may obtain (240) the first paging identifier 205 for scrambling first paging information 215 scheduling a first paging message for a transmission of an application level feedback to a terminal device 110. The access network device 120 may transmit (260), to the terminal device 110, the first paging information 215 scrambled with the first paging identifier 205. The terminal device 110 may monitor (270), using the first paging identifier 205, the first paging information 215 from the access network device 120.

In this way, the access network device 120 and the terminal device 110 can differentiate between paging concerning new data and application level feedback. This results in reduced paging probability and reduced energy consumption of the terminal device 110.

In some embodiments, in order to obtain the first paging identifier, the access network device 120 may select one of a group of paging identifiers as the first paging identifier, based on at least one of a cell identifier or a satellite identifier associated with a cell to which the terminal device 110 last connected. For example, the first paging identifier selection at the target cell may be determined based on a hash function from group of the first paging identifier based on last connected cell (or satellite) of the terminal device 110 to be paged.

In some embodiments, in order to obtain the first paging identifier, the terminal device 110 may determine at least one of a cell identifier or a satellite identifier associated with a cell to which the terminal device 110 transmitted the application level data corresponding to the application level feedback, and determine the first paging identifier based on the second paging identifier and the at least one of the cell identifier or the satellite identifier. For example, the terminal device 110 may automatically monitor for the first paging identifier, which is associated with the last connected cell (or satellite) if the terminal device 110 has transferred uplink data and is expecting application layer feedback. The association can be based on a mapping from cell identifier (or satellite identifier) to the first paging identifier, e.g. the first paging identifier equals the second paging identifier minus cell identifier.

In some embodiments, the terminal device 110 may obtain the first paging identifier from pre-programmed information. For example, the first paging identifier may be a hardcoded value different from the second paging identifier. The hardcoded value can be programmed in the terminal device 110 during manufacturing.

In some embodiments, the terminal device 110 may obtain the first paging identifier from the access network device 120. The access network device 120 may receive the first paging identifier from the core network device 130 associated with the terminal device 110.

On the side of the core network device 130, in some embodiments, in order to determine the first paging identifier, the core network device 130 may determine at least one of a cell identifier or a satellite identifier associated with a cell to which the terminal device 110 last connected, and determine the first paging identifier based on the second paging identifier and the at least one of the cell identifier or the satellite identifier.

In some embodiments, the first paging identifier comprises a store and forward paging radio network temporary identifier (SF-P-RNTI). In some embodiments, the second paging identifier comprises a paging radio network temporary identifier (P-RNTI). In some embodiments PCI may be an example of the cell identifier, and SAT ID may be an example of the satellite identifier.

On the side of the core network device 130, in some embodiments, the core network device 130 may generate the first paging message including a temporary identifier specific to the terminal device 110 for receiving the application level feedback, and transmit the first paging message to the access network device 120 for transmitting to the terminal device 110.

In some embodiments, the terminal device 110 may receive, using the first paging identifier, the first paging information from the access network device 120, and receive the first paging message from the access network device 120 based on the first paging information.

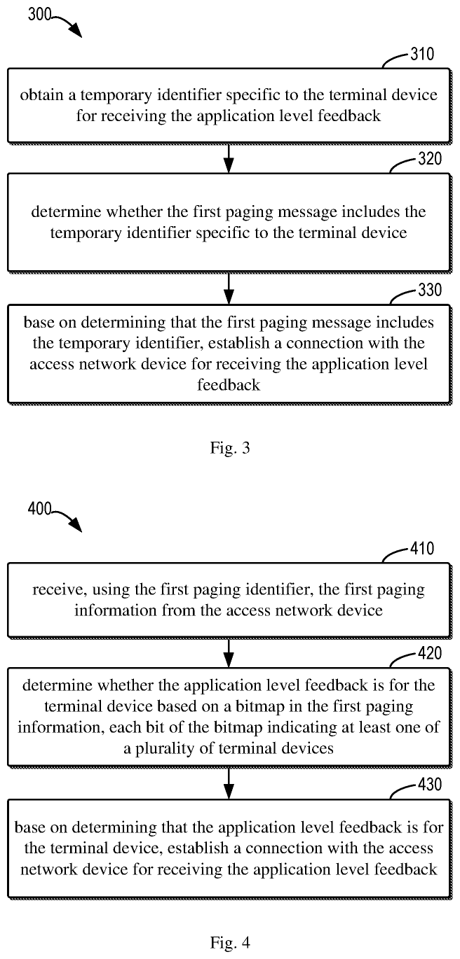

FIG. 3 illustrates flow diagram 300 of terminal device 110 receiving the application level feedback from the access network device 120 in accordance with some embodiments of the present disclosure. As shown in FIG. 3, at block 310, the terminal device 110 may obtain a temporary identifier specific to the terminal device 110 for receiving the application level feedback. At block 320, the terminal device 110 may determine whether the first paging message includes the temporary identifier specific to the terminal device 110. At block 330, the terminal device 110 may base on determining that the first paging message includes the temporary identifier, establish a connection with the access network device 120 for receiving the application level feedback.

In some embodiments, the terminal device 110 may obtain the temporary identifier and the first paging identifier at the time of a connection between the access network device 120 and the terminal device 110 is released.

In some embodiments, the access network device 120 may determine to release a connection between the access network device 120 and the terminal device 110, and transmit, to the terminal device 110, a connection release message including at least one of the temporary identifier and the first paging identifier.

In some embodiments, the access network device 120 may receive, from a core network device 130 associated with the terminal device 110, the first paging message including a temporary identifier specific to the terminal device 110 for receiving the application level feedback.

In some embodiments, the access network device 120 may determine that the application level feedback is for the terminal device 110, and based on determining that the application level feedback is for the terminal device 110, generate the first paging message to include a temporary identifier specific to the terminal device 110 for receiving the application level feedback.

In some embodiments, the terminal device 110 may obtain the temporary identifier by receiving the temporary identifier from a previous access network device 120 to which the terminal device 110 last connected. In some embodiments, the temporary identifier comprises a store and forward radio network temporary identifier (SF-RNTI).

In some embodiments, there are a plurality of terminal devices 110 waiting for the application level feedback, and the flow diagram of terminal device 110 receiving the application level feedback from the access network device 120 may be shown as FIG. 4. With reference to FIG. 4, at block 410, the terminal device 110 may receive, using the first paging identifier, the first paging information from the access network device 120. at block 420, the terminal device 110 may determine whether the application level feedback is for the terminal device 110 based on a bitmap in the first paging information, each bit of the bitmap indicating at least one of a plurality of terminal devices 110. at block 430, the terminal device 110 may base on determining that the application level feedback is for the terminal device 110, establish a connection with the access network device 120 for receiving the application level feedback.

On the side of the access network device 120, in some embodiments, the access network device 120 may determine that the first paging information is to schedule the first paging message for a plurality of transmissions of application level feedbacks to a plurality of terminal devices 110, the terminal device 110 may be one of the plurality of terminal devices 110. The access network device 120 may generate the first paging information to include a bitmap to indicate the terminal device 110, each bit of the bitmap indicating one of the plurality of terminal devices 110.

In some embodiments, the access network device 120 may be a non-terrestrial network device. In some embodiments, the terminal device 110 may be an IoT UE. In the basic scenario of some embodiments of the present disclosure, attributes of IoT traffic and the features for enhanced performance include, for example, IoT data traffic, and mostly small data transmission with few packets of transmission, and application ACK is optional, in addition, periodic data transmissions are not time critical, and emergency transmissions (exception reports) need to reach application within certain duration (for example 10 seconds—requirement for CIoT).

In order to differentiate between paging for delivering application level ACK (or application level information/feedback in general) and paging for new data transmission, in some embodiments, the UE may be assigned a different RNTI (Radio Network Temporary Identifier) to use when monitoring the paging DCI (Downlink Control Information). Alternatively or additionally, the UE may be assigned a different RNTI to use when monitoring the paging message (compared to legacy use of P-RNTI and UE ID). The different RNTI(s) are used by the network when paging the UE with application level feedback.

In some embodiments, SF-P-RNTI (Store and forward paging RNTI) can be assigned based on last connected cell (or satellite). This will enable the target cell paging to differentiate between the application level feedback and paging belonging to different, new data transmissions. SF-P-RNTI selection at the target cell will be determined based on a hash function from group of SF-P-RNTI based on last connected cell (or satellite) of the UE to be paged.

In some embodiments, alternatively, UE will automatically monitor for the SF-P-RNTI, which is associated with the last connected cell (or satellite) if UE has transferred uplink data and is expecting application layer feedback. The association can be based on a mapping from PCI (or SAT ID) to SF-P-RNTI, e.g. SF-P-RNTI=P-RNTI-PCI.

In some embodiments, on the side of the CN (for example, the core network device 130), MME may indicate to the RAN (Radio Access Network) what SF-P-RNTI to use for a specific UE, based on the MME being aware of which cell/satellite received the original uplink data. In these embodiments, SF-RNTI (Store and forward RNTI) based on last connected-cell is used for RAN Paging Differentiation for store and forward application level feedback packets.

In some embodiments, the RNTI(s) can be a fixed value configured by NW (network). UE waiting for application level information in next (satellite) connectivity occasion is assigned with new paging identifier (SF-RNTI) uniquely different from P-RNTI by RAN at the time of RRC (Radio Resource Control) connection release. SGW of the CN to indicate flag in downlink notification to MME that the packets are in response to UE originated packets (i.e. application level feedback). MME should include this flag in the paging message. The UE will monitor for this SF-RNTI in the paging message to determine if there is application level feedback.

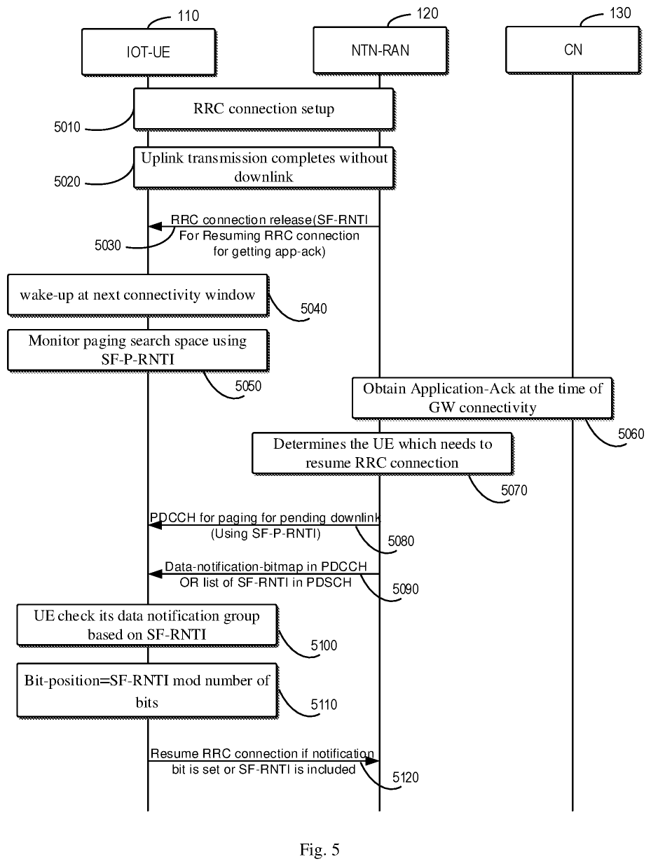

With reference to FIG. 5 which is the message sequence diagram for paging differentiation for SF paging message along with enhancement for group based application feedback notification. As shown in FIG. 5, IoT UE (may be called UE for short, an example of the terminal device 110) may establish (5010) a RRC connection with the NTN-RAN (an example of the access network device 120). After the RRC connection is setup, the UE and the NTN-RAN may complete (5020) uplink transmission without downlink transmission, then the RRC connection is released (5030), and the UE will wait for application level ACK (i.e. app-ack or Application-Ack) of downlink transmission corresponding to the uplink transmission. The NTN-RAN transmits a connection release message to the UE, and the connection release message may include at least one of the SF-RNTI and the SF-P-RNTI. SF-RNTI is for resuming RRC connection for getting app-ack.

When the UE wakes up next time, monitors the search space for “application level feedback” using SF-P-RNTI. The UE may wake-up (5040) at next connectivity window and monitor (5050) paging search space using the SF-P-RNTI. The UE may monitor for SF-RNTI in the paging message to determine if there is application level feedback. Indication of UE specific information is used for paging differentiation to receive application level feedback.

On the side of the NTN-RAN, the NTN-RAN may obtain (5060) Application-Ack at the time of GW connectivity, and determine (5070) the UE which needs to resume RRC connection.

In some embodiments, the RNTI(s) can be assigned to the UE based on last serving cell/satellite. The NTN-RAN may use different P-RNTI (i.e. SF-P-RNTI) for sending PDCCH (Physical Downlink Control Channel) for triggering connection setup for pending application level feedback as compared to the legacy P-RNTI. In some embodiments, the NTN-RAN may transmit (5080) PDCCH for paging for pending downlink (using SF-RNTI) , and transmit (5090) data-notification-bitmap in PDCCH or list of SF-RNTI in PDSCH (Physical Downlink Shared Channel). In some embodiments, DCI contents may include ‘Data-notification’ bitmap or downlink grant where list of SF-RNTI that needs to resume RRC connection is given.

On the side of the UE, the UE may check (5100) its data notification group based on SF-RNTI, for example, when two SF-RNTI are mapped to the same PO (Paging Occasion) based on their S-TMSI, the SF-RNTI is used to identify (5110) the position within the bitmap of ‘Data-notification’ sent in PDCCH (paging DCI) or PDSCH (paging message). SF-RNTI mod number of bits is used for this purpose, in some embodiments, bit-position=SF-RNTI mod number of bits. The UE resume (5120) connection to get application level feedback if there is ‘data-notification’to it in PDCCH or PDSCH.

In this way, it is realized that enabling the network and UE to differentiate between paging concerning new data and application level feedback. This results in reduced paging probability and reduced UE energy consumption. In addition, the SF-P-RNTI enables a cell to indicate whether new data or application layer feedback, based on a past transmission to a specific cell linked to the SF-P-RNTI, is ready for transfer. In some embodiments, the Paging Occasion (PO) used for legacy RRC Idle mode paging can also be used for paging for application level feedback.

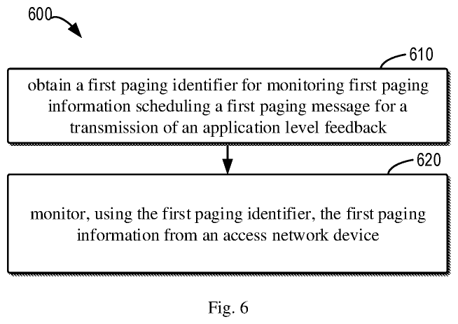

FIG. 6 shows a flowchart of an example method 600 implemented at the terminal device 110 in accordance with some embodiments of the present disclosure. At block 610, the terminal device 110 may obtain a first paging identifier for monitoring first paging information scheduling a first paging message for a transmission of an application level feedback. The first paging identifier is different from a second paging identifier for monitoring second paging information scheduling a second paging message for a data transmission. At block 620, the terminal device 110 may monitor, using the first paging identifier, the first paging information from an access network device 120.

In some embodiments, the terminal device 110 obtains a first paging identifier by determining at least one of a cell identifier or a satellite identifier associated with a cell to which the terminal device transmitted the application level data corresponding to the application level feedback; and determining the first paging identifier based on the second paging identifier and the at least one of the cell identifier or the satellite identifier.

In some embodiments, the terminal device 110 obtains a first paging identifier by obtaining the first paging identifier from pre-programmed information.

In some embodiments, the method 600 further comprises receiving, using the first paging identifier, the first paging information from the access network device 120; and receiving the first paging message from the access network device 120 based on the first paging information.

In some embodiments, the method 600 further comprises obtaining a temporary identifier specific to the terminal device for receiving the application level feedback; determining whether one of the first paging message and the second paging message includes the temporary identifier specific to the terminal device; and based on determining that the first paging message includes the temporary identifier, establishing a connection with the access network device 120 for receiving the application level feedback.

In some embodiments, the terminal device 110 obtains the temporary identifier by receiving the temporary identifier from a previous access network device 120 to which the terminal device last connected.

In some embodiments, the method 600 further comprises receiving, using the first paging identifier, the first paging information from the access network device 120; determining whether the application level feedback is for the terminal device based on a bitmap in the first paging information, each bit of the bitmap indicating at least one of a plurality of terminal devices; and based on determining that the application level feedback is for the terminal device, establishing a connection with the access network device 120 for receiving the application level feedback.

In some embodiments, the method 600 further comprises at least one of: the first paging identifier comprises a store and forward paging radio network temporary identifier (SF-P-RNTI); the second paging identifier comprises a paging radio network temporary identifier (P-RNTI); or the temporary identifier comprises a store and forward radio network temporary identifier (SF-RNTI).

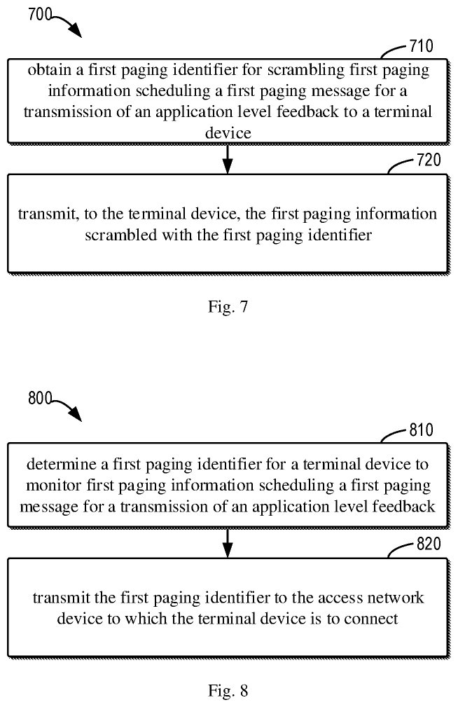

FIG. 7 shows a flowchart of an example method 700 implemented at the access network device 120 in accordance with some embodiments of the present disclosure. At block 710, the access network device 120 may obtain a first paging identifier for scrambling first paging information scheduling a first paging message for a transmission of an application level feedback to a terminal device 110. The first paging identifier is different from a second paging identifier for scrambling second paging information scheduling a second paging message for a data transmission to the terminal device. At block 720, the access network device 120 may transmit, to the terminal device 110, the first paging information scrambled with the first paging identifier.

In some embodiments, the access network device 120 obtains the first paging identifier by selecting one of a group of paging identifiers as the first paging identifier, based on at least one of a cell identifier or a satellite identifier associated with a cell to which the terminal device last connected.

In some embodiments, the access network device 120 obtains the first paging identifier by receiving the first paging identifier from a core network device 130 associated with the terminal device.

In some embodiments, the method 700 further comprises determining that the application level feedback is for the terminal device; and based on determining that the application level feedback is for the terminal device, generating the first paging message to include a temporary identifier specific to the terminal device for receiving the application level feedback.

In some embodiments, the method 700 further comprises determining to release a connection between the access network device 120 and the terminal device 110; and transmitting, to the terminal device 110, a connection release message including at least one of the temporary identifier and the first paging identifier.

In some embodiments, the method 700 further comprises receiving, from a core network device 130 associated with the terminal device 110, the first paging message including a temporary identifier specific to the terminal device 110 for receiving the application level feedback.

In some embodiments, the method 700 further comprises determining that the first paging information is to schedule the first paging message for a plurality of transmissions of application level feedbacks to a plurality of terminal devices 110, the terminal device 110 being one of the plurality of terminal devices; and generating the first paging information to include a bitmap to indicate the terminal device 110, each bit of the bitmap indicating one of the plurality of terminal devices 110.

In some embodiments, wherein at least one of: the first paging identifier comprises a store and forward paging radio network temporary identifier (SF-P-RNTI); the second paging identifier comprises a paging radio network temporary identifier (P-RNTI); or the temporary identifier comprises a store and forward radio network temporary identifier (SF-RNTI).

In some embodiments, wherein the access network device 120 being a non-terrestrial network device.

FIG. 8 shows a flowchart of an example method 900 implemented at a core network device 130 in accordance with some embodiments of the present disclosure. At block 810, the core network device 130 may determine a first paging identifier for a terminal device to monitor first paging information scheduling a first paging message for a transmission of an application level feedback. The first paging identifier being different from a second paging identifier for the terminal device 110 to monitor second paging information scheduling a second paging message for a data transmission. At block 820, the core network device 130 may transmit the first paging identifier to the access network device 120 to which the terminal device 110 is to connect.

In some embodiments, the core network device 130 determines the first paging identifier by determining at least one of a cell identifier or a satellite identifier associated with a cell to which the terminal device last connected; and determining the first paging identifier based on the second paging identifier and the at least one of the cell identifier or the satellite identifier.

In some embodiments, the method 800 further comprises generating the first paging message including a temporary identifier specific to the terminal device 110 for receiving the application level feedback; and transmitting the first paging message to the access network device 120 for transmitting to the terminal device 110.

In some embodiments, wherein at least one of: the first paging identifier comprises a store and forward paging radio network temporary identifier (SF-P-RNTI); the second paging identifier comprises a paging radio network temporary identifier (P-RNTI); or the temporary identifier comprises a store and forward radio network temporary identifier (SF-RNTI).

In some embodiments, an apparatus capable of performing any of the method 600 (for example, the terminal device 110) may comprise means for performing the respective steps of the method 600. The means may be implemented in any suitable form. For example, the means may be implemented in a circuitry or software module.

In some embodiments, the apparatus comprises means for obtaining, at a terminal device 110, a first paging identifier for monitoring first paging information scheduling a first paging message for a transmission of an application level feedback, the first paging identifier being different from a second paging identifier for monitoring second paging information scheduling a second paging message for a data transmission; and means for monitoring, using the first paging identifier, the first paging information from an access network device 120.

In some embodiments, the means for obtaining the first paging identifier comprises: means for determining at least one of a cell identifier or a satellite identifier associated with a cell to which the terminal device transmitted the application level data corresponding to the application level feedback; and means for determining the first paging identifier based on the second paging identifier and the at least one of the cell identifier or the satellite identifier.

In some embodiments, the means for obtaining the first paging identifier comprises: means for obtaining the first paging identifier from pre-programmed information.

In some embodiments, the apparatus further comprises means for receiving, using the first paging identifier, the first paging information from the access network device; and means for receiving the first paging message from the access network device based on the first paging information.

In some embodiments, the apparatus further comprises means for obtaining a temporary identifier specific to the terminal device for receiving the application level feedback; means for determining whether one of the first paging message and the second paging message includes the temporary identifier specific to the terminal device; and means for based on determining that the first paging message includes the temporary identifier, establish a connection with the access network device for receiving the application level feedback.

In some embodiments, the means for obtaining the temporary identifier comprises: means for receiving the temporary identifier from a previous access network device to which the terminal device last connected.

In some embodiments, the apparatus further comprises means for receiving, using the first paging identifier, the first paging information from the access network device; means for determining whether the application level feedback is for the terminal device based on a bitmap in the first paging information, each bit of the bitmap indicating at least one of a plurality of terminal devices; and means for based on determining that the application level feedback is for the terminal device, establish a connection with the access network device for receiving the application level feedback.

In some embodiments, wherein at least one of: the first paging identifier comprises a store and forward paging radio network temporary identifier (SF-P-RNTI); the second paging identifier comprises a paging radio network temporary identifier (P-RNTI); or the temporary identifier comprises a store and forward radio network temporary identifier (SF-RNTI).

In some embodiments, the apparatus further comprises means for performing other steps in some embodiments of the method 700. In some embodiments, the means comprises at least one processor; and at least one memory including computer program code, the at least one memory and computer program code configured to, with the at least one processor, cause the performance of the apparatus.

In some embodiments, an apparatus capable of performing any of the method 700 (for example, the network device 120) may comprise means for performing the respective steps of the method 700. The means may be implemented in any suitable form. For example, the means may be implemented in a circuitry or software module.

In some embodiments, the apparatus comprises means for obtaining, at an access network device 120, a first paging identifier for scrambling first paging information scheduling a first paging message for a transmission of an application level feedback to a terminal device, the first paging identifier being different from a second paging identifier for scrambling second paging information scheduling a second paging message for a data transmission to the terminal device 110; and means for transmitting, to the terminal device 110, the first paging information scrambled with the first paging identifier.

In some embodiments, the means for obtaining the first paging identifier comprises: means for selecting one of a group of paging identifiers as the first paging identifier, based on at least one of a cell identifier or a satellite identifier associated with a cell to which the terminal device last connected.

In some embodiments, the means for obtaining the first paging identifier comprises: means for receiving the first paging identifier from a core network device associated with the terminal device.

In some embodiments, the apparatus further comprises means for determining that the application level feedback is for the terminal device; and means for based on determining that the application level feedback is for the terminal device, generating the first paging message to include a temporary identifier specific to the terminal device for receiving the application level feedback.

In some embodiments, the apparatus further comprises means for determining to release a connection between the access network device and the terminal device; and means for transmitting, to the terminal device, a connection release message including at least one of the temporary identifier and the first paging identifier.

In some embodiments, the apparatus further comprises means for receiving, from a core network device associated with the terminal device, the first paging message including a temporary identifier specific to the terminal device for receiving the application level feedback.

In some embodiments, the apparatus further comprises means for determining that the first paging information is to schedule the first paging message for a plurality of transmissions of application level feedbacks to a plurality of terminal devices, the terminal device being one of the plurality of terminal devices; and means for generating the first paging information to include a bitmap to indicate the terminal device, each bit of the bitmap indicating one of the plurality of terminal devices.

In some embodiments, wherein at least one of: the first paging identifier comprises a store and forward paging radio network temporary identifier (SF-P-RNTI); the second paging identifier comprises a paging radio network temporary identifier (P-RNTI); or the temporary identifier comprises a store and forward radio network temporary identifier (SF-RNTI).

In some embodiments, wherein the access network device is a non-terrestrial network device.

In some embodiments, the apparatus further comprises means for performing other steps in some embodiments of the method 700. In some embodiments, the means comprises at least one processor; and at least one memory including computer program code, the at least one memory and computer program code configured to, with the at least one processor, cause the performance of the apparatus.

In some embodiments, an apparatus capable of performing any of the method 800 (for example, the core network device 130) may comprise means for performing the respective steps of the method 800. The means may be implemented in any suitable form. For example, the means may be implemented in a circuitry or software module.

In some embodiments, the apparatus comprises means for determining, at a core network device 130, a first paging identifier for a terminal device to monitor first paging information scheduling a first paging message for a transmission of an application level feedback, the first paging identifier being different from a second paging identifier for the terminal device to monitor second paging information scheduling a second paging message for a data transmission; and means for transmitting the first paging identifier to an access network device 120 to which the terminal device 110 is to connect.

In some embodiments, the means for determining the first paging identifier comprises: means for determining at least one of a cell identifier or a satellite identifier associated with a cell to which the terminal device last connected; and means for determining the first paging identifier based on the second paging identifier and the at least one of the cell identifier or the satellite identifier.

In some embodiments, the apparatus further comprises means for generating the first paging message including a temporary identifier specific to the terminal device for receiving the application level feedback; and means for transmitting the first paging message to the access network device for transmitting to the terminal device.

In some embodiments, wherein at least one of: the first paging identifier comprises a store and forward paging radio network temporary identifier (SF-P-RNTI); the second paging identifier comprises a paging radio network temporary identifier (P-RNTI); or the temporary identifier comprises a store and forward radio network temporary identifier (SF-RNTI).

In some embodiments, the apparatus further comprises means for performing other steps in some embodiments of the method 800. In some embodiments, the means comprises at least one processor; and at least one memory including computer program code, the at least one memory and computer program code configured to, with the at least one processor, cause the performance of the apparatus.

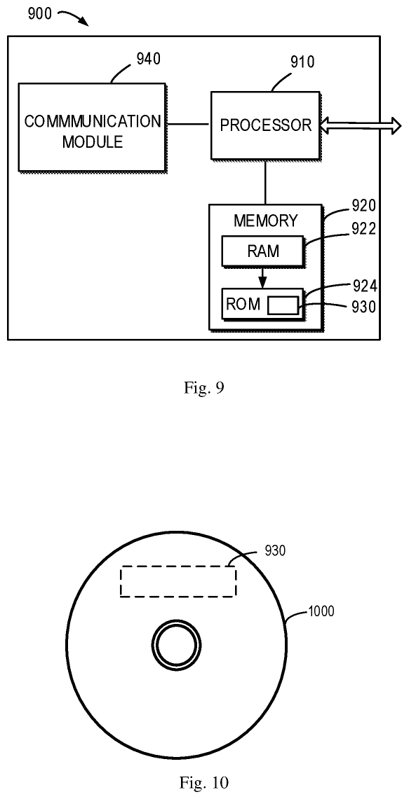

FIG. 9 is a simplified block diagram of a device 900 that is suitable for implementing embodiments of the present disclosure. The device 900 may be provided to implement the communication device, for example the terminal device 110, the access network device 120 or the core network device 130 as shown in FIG. 1A. As shown, the device 900 includes one or more processors 910, one or more memories 940 coupled to the processor 910, and one or more transmitters and/or receivers (TX/RX) 940 coupled to the processor 910.

The TX/RX 940 is for bidirectional communications. The TX/RX 940 has at least one antenna to facilitate communication. The communication interface may represent any interface that is necessary for communication with other network elements.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The program 930 may be stored in the ROM 920. The processor 910 may perform any suitable actions and processing by loading the program 930 into the RAM 920.

The embodiments of the present disclosure may be implemented by means of the program 930 so that the device 900 may perform any process of the disclosure as discussed with reference to FIGS. 2 to 9. The embodiments of the present disclosure may also be implemented by hardware or by a combination of software and hardware.

In some embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. The computer readable medium may include any types of tangible non-volatile storage, such as ROM, EPROM, a flash memory, a hard disk, CD, DVD, and the like. FIG. 10 shows an example of the computer readable medium 1000 in form of CD or DVD. The computer readable medium has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 600 as described above with reference to FIGS. 2-9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device comprising:
at least one processor; and
at least one memory storing instructions that, when executed by the at least one processor, cause the terminal device at least to:
obtain a first paging identifier for monitoring first paging information scheduling a first paging message for a transmission of an application level feedback, the first paging identifier being different from a second paging identifier for monitoring second paging information scheduling a second paging message for a data transmission; and
monitor, using the first paging identifier, the first paging information from an access network device.

2. The terminal device of claim 1, wherein the terminal device is caused to obtain the first paging identifier by:
determining at least one of a cell identifier or a satellite identifier associated with a cell to which the terminal device transmitted the application level data corresponding to the application level feedback; and
determining the first paging identifier based on the second paging identifier and the at least one of the cell identifier or the satellite identifier.

3. The terminal device of claim 1, wherein the terminal device is caused to obtain the first paging identifier by:
obtaining the first paging identifier from pre-programmed information.

4. The terminal device of claim 1, wherein the terminal device is further caused to:
receive, using the first paging identifier, the first paging information from the access network device; and
receive the first paging message from the access network device based on the first paging information.

5. The terminal device of claim 4, wherein the terminal device is further caused to:
obtain a temporary identifier specific to the terminal device for receiving the application level feedback;
determine whether one of the first paging message and the second paging message includes the temporary identifier specific to the terminal device; and
based on determining that the first paging message includes the temporary identifier, establish a connection with the access network device for receiving the application level feedback.

6. The terminal device of claim 45, wherein the terminal device is further caused to:
obtain a temporary identifier specific to the terminal device for receiving the application level feedback, wherein the terminal device is caused to obtain the temporary identifier by receiving the temporary identifier from a previous access network device to which the terminal device last connected;
determine whether one of the first paging message and the second paging message includes the temporary identifier specific to the terminal device; and
based on determining that the first paging message includes the temporary identifier, establish a connection with the access network device for receiving the application level feedback.

7. The terminal device of claim 1, wherein the terminal device is further caused to:
receive, using the first paging identifier, the first paging information from the access network device;
determine whether the application level feedback is for the terminal device based on a bitmap in the first paging information, each bit of the bitmap indicating at least one of a plurality of terminal devices; and
based on determining that the application level feedback is for the terminal device, establish a connection with the access network device for receiving the application level feedback.

8. The terminal device of claim 1, wherein at least one of:
the first paging identifier comprises a store and forward paging radio network temporary identifier (SF-P-RNTI);
the second paging identifier comprises a paging radio network temporary identifier (P-RNTI); or
the temporary identifier comprises a store and forward radio network temporary identifier (SF-RNTI).

9. An access network device comprising:
at least one processor; and
at least one memory storing instructions that, when executed by the at least one processor, cause the access network device at least to:
obtain a first paging identifier for scrambling first paging information scheduling a first paging message for a transmission of an application level feedback to a terminal device, the first paging identifier being different from a second paging identifier for scrambling second paging information scheduling a second paging message for a data transmission to the terminal device; and
transmit, to the terminal device, the first paging information scrambled with the first paging identifier.

10. The access network device of claim 9, wherein the access network device is caused to obtain the first paging identifier by:
selecting one of a group of paging identifiers as the first paging identifier, based on at least one of a cell identifier or a satellite identifier associated with a cell to which the terminal device last connected.

11. The access network device of claim 9, wherein the access network device is caused to obtain the first paging identifier by:
receiving the first paging identifier from a core network device associated with the terminal device.

12. The access network device of claim 9, wherein the access network device is further caused to:
determine that the application level feedback is for the terminal device; and
based on determining that the application level feedback is for the terminal device, generate the first paging message to include a temporary identifier specific to the terminal device for receiving the application level feedback.

13. The access network device of claim 12, wherein the access network device is further caused to:
determine to release a connection between the access network device and the terminal device; and
transmit, to the terminal device, a connection release message including at least one of the temporary identifier and the first paging identifier.

14. The access network device of claim 9, wherein the access network device is further caused to:
receive, from a core network device associated with the terminal device, the first paging message including a temporary identifier specific to the terminal device for receiving the application level feedback.

15. The access network device of claim 9, wherein the access network device is further caused to:
determine that the first paging information is to schedule the first paging message for a plurality of transmissions of application level feedbacks to a plurality of terminal devices, the terminal device being one of the plurality of terminal devices; and
generate the first paging information to include a bitmap to indicate the terminal device, each bit of the bitmap indicating one of the plurality of terminal devices.

16. The access network device of claim 9, wherein at least one of:
the first paging identifier comprises a store and forward paging radio network temporary identifier (SF-P-RNTI);
the second paging identifier comprises a paging radio network temporary identifier (P-RNTI); or
the temporary identifier comprises a store and forward radio network temporary identifier (SF-RNTI).

17. The access network device of claim 9, wherein the access network device is a non-terrestrial network device.

18. A core network device comprising:
at least one processor; and
at least one memory storing instructions that, when executed by the at least one processor, cause the core network device at least to:
determine a first paging identifier for a terminal device to monitor first paging information scheduling a first paging message for a transmission of an application level feedback, the first paging identifier being different from a second paging identifier for the terminal device to monitor second paging information scheduling a second paging message for a data transmission; and
transmit the first paging identifier to an access network device to which the terminal device is to connect.

19. The core network device of claim 18, wherein the core network device is caused to determine the first paging identifier by:
determining at least one of a cell identifier or a satellite identifier associated with a cell to which the terminal device last connected; and
determining the first paging identifier based on the second paging identifier and the at least one of the cell identifier or the satellite identifier.

20. The core network device of claim 18[[or 19]], wherein the core network device is further caused to:
generate the first paging message including a temporary identifier specific to the terminal device for receiving the application level feedback; and
transmit the first paging message to the access network device for transmitting to the terminal device.

21-28. (canceled)
